(19) United States
(12) Patent Application Publication
(10) Pub. No.: US 2019/0147761 A1
(43) Pub. Date: May 16, 2019

(54) SYSTEMS AND METHODS FOR DIAGNOSING AND REMEDIATING A MISCONCEPTION

(71) Applicant: KNOWLEDGEHOOK INC., Kitchener (CA)

(72) Inventor: Travis RATNAM, Toronto (CA)

(21) Appl. No.: 16/098,390

(22) PCT Filed: May 3, 2017
(86) PCT No.: PCT/CA2017/050535

§ 371 Date: Nov. 1, 2018

Related U.S. Application Data
(60) Provisional application No. 62/331,231, filed on May 3, 2016.

(51) Int. Cl. G09B 7/06; G09B 5/10

(52) U.S. Cl. CPC G09B 7/06; G09B 5/10

(57) ABSTRACT

A system and method for diagnosing and remediating a misconception includes a server device in communication, via a network, with a plurality of student devices each associated with a student user at least one teacher device associated with a teacher user and at least one administrator device associated with an administrator user. The server device is configured to provide diagnostic questions to the student devices, receive responses from the student devices, determine if the responses are linked to a misconception, and where the response is linked to a misconception, send a prescriptive training plan to the teacher device.

### TECHNICAL FIELD

The embodiments disclosed herein relate to systems and methods for diagnosing and remediating a misconception, and, in particular to computer systems and methods for collecting evidence, diagnosing a misconception, and prescribing remediation.

### INTRODUCTION

Math outcomes may be improved when teachers know the best teaching practices for every math topic they teach. Further, teachers who regularly find opportunities to understand their students' needs and tailor their teaching practices can increase the efficacy of student learning. Administrators can help support the teachers to address the students' needs while parents can be included to help address their children's issues.

However, achieving these goals can be difficult since school boards and teachers are often faced with problems relating to collecting evidence, delivering insights, and supporting implementation of effective practices derived from those insights. Teachers may also have difficulty diagnosing and remediating student misconceptions as the teacher needs specific training on each misconception to know how to recognize and remediate the misconception. In particular, there is difficulty when collecting student data and drawing insights, coordinating parents, teachers, principals, and administrators to take action on insights, and providing the necessary support to facilitate implementation.

The systems and methods for diagnosing and remediating a misconception described herein may address these challenges by proactively informing administrators, teachers, and parents about the proven teaching practices that can best treat their students' highest priority needs.

### SUMMARY

The system includes a web platform to help teachers improve math outcomes. On the surface, the system may make it fun for students to practice math either as a group or individually. Behind the scenes, the system may improve the quality of teaching by identifying students' needs and offering evidence-based professional development to teachers.

According to some embodiments, there is a computer system for diagnosing and remediating at least one misconception. The system includes a server device in communication, via a network, with a plurality of student devices each associated with a student user at least one teacher device associated with a teacher user and at least one administrator device associated with an administrator user. The server device is configured to provide diagnostic questions to the student devices, receive responses from the student devices, determine if the responses are linked to a misconception, and where the response is linked to a misconception, send a prescriptive training plan to the teacher device.

The server device may be further configured to send the prescriptive training plan to the administrator device. The prescriptive training plan may train the teacher how to properly characterize a solution to the common misconception. The teacher device may receive the prescriptive training plan and the teacher user may deliver the prescriptive training plan to the student users.

The prescriptive training plan may include visual elements for display to the student users. The prescriptive training plan may include a misconception definition that describes the issue faced by the student as well as misconception reasons for why the student may struggle with the misconception. The prescriptive training plan may include an open approach including open ended questions that the teacher delivers directly to the students. The prescriptive training plan may include a background describing the details of the underlying problem and the background of the particular misconception. The prescriptive training plan may include a guided approach including specific questions that the teacher delivers directly to the students. The prescriptive training plan may include a set of exit questions, for individual student delivery or group delivery.

According to some embodiments, there is a method for diagnosing and remediating at least one misconception. The method includes providing diagnostic questions to student devices, receiving responses from the student devices, determining if the responses are linked to a misconception, where the response is a misconception, sending a prescriptive training plan to a teacher device.

The method may further include sending the prescriptive training plan to an administrator device. The method may further include, at the teacher device, receiving the prescriptive training plan. The method may further include delivering the prescriptive training plan to the student users.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a diagram of a system for diagnosing and remediating a misconception, in accordance with an embodiment;

FIGS. 2A, 2B, and 2C are a flow chart of a method for diagnosing and remediating a misconception, in accordance with an embodiment;

FIG. 3 is a flow chart of a method for diagnosing and remediating a misconception, in accordance with a further embodiment;

FIG. 4 is a flow chart of the method of FIG. 3, in accordance with a particular embodiment;

FIG. 5 is a diagram of a diagnostic and a prescription, in accordance with an embodiment;

FIGS. 6A to 6G is an example teaching prescription of FIG. 5;

FIGS. 7A to 7G is a teaching prescription, in accordance with a further embodiment; and

FIGS. 8A to 8G is a teaching prescription, in accordance with a further embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to systems or processes having all of the features of any one systems or process described below or to features common to multiple or all of the systems described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud based program or system, laptop, personal data assistance, cellular telephone, smartphone, or tablet device.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

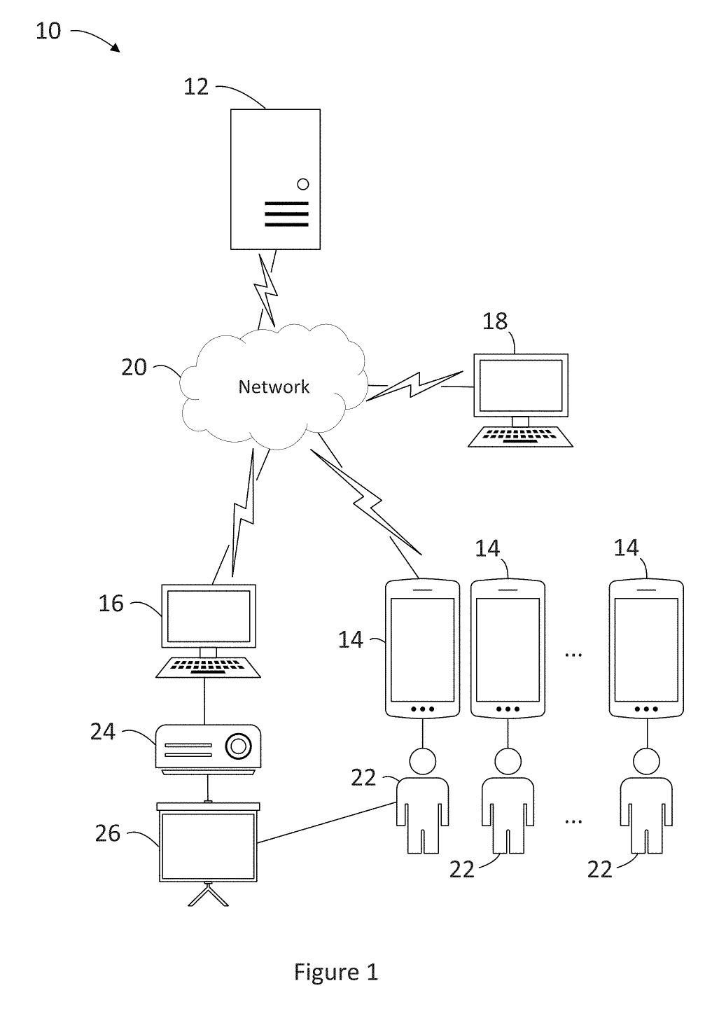

FIG. 1 shows a block diagram illustrating a system 10 for diagnosing and remediating at least one misconception, in accordance with an embodiment. A misconception is an incorrect response that has an underlying reason that the student would respond incorrectly as compared to an incorrect response without any reason.

The system 10 includes a server device 12 which communicates with a plurality of student devices 14, a plurality of teacher devices 16, and a plurality of administrator devices 18 via a network 20. The server device 12 may be a purpose built machine designed specifically for implementing a system and method for diagnosing and remediating a misconception. The server device 12 delivers a teaching training guide of human-inquiry based questions in the absence of technology.

The server device 12, student devices 14, teacher devices 16, and administrator devices 18 may be a server computer, desktop computer, notebook computer, tablet, PDA, smartphone, or another computing device. The devices 12, 14, 16, 18 may include a connection with the network 20 such as a wired or wireless connection to the Internet. In some cases, the network 20 may include other types of computer or telecommunication networks. The devices 12, 14, 16, 18 may include one or more of a memory, a secondary storage device, a processor, an input device, a display device, and an output device. Memory may include random access memory (RAM) or similar types of memory. Also, memory may store one or more applications for execution by processor. Applications may correspond with software modules comprising computer executable instructions to perform processing for the functions described below. Secondary storage device may include a hard disk drive, floppy disk drive, CD drive, DVD drive, Blu-ray drive, or other types of non-volatile data storage. Processor may execute applications, computer readable instructions or programs. The applications, computer readable instructions or programs may be stored in memory or in secondary storage, or may be received from the Internet or other network 20. Input device may include any device for entering information into device 12, 14, 16, 18. For example, input device may be a keyboard, key pad, cursor-control device, touch-screen, camera, or microphone. Display device may include any type of device for presenting visual information. For example, display device may be a computer monitor, a flat-screen display, a projector or a display panel. Output device may include any type of device for presenting a hard copy of information, such as a printer for example. Output device may also include other types of output devices such as speakers, for example. In some cases, device 12, 14, 16, 18 may include multiple of any one or more of processors, applications, software modules, second storage devices, network connections, input devices, output devices, and display devices.

Although devices 12, 14, 16, 18 are described with various components, one skilled in the art will appreciate that the devices 12, 14, 16, 18 may in some cases contain fewer, additional or different components. In addition, although aspects of an implementation of the devices 12, 14, 16, 18 may be described as being stored in memory, one skilled in the art will appreciate that these aspects can also be stored on or read from other types of computer program products or computer-readable media, such as secondary storage devices, including hard disks, floppy disks, CDs, or DVDs; a carrier wave from the Internet or other network; or other forms of RAM or ROM. The computer-readable media may include instructions for controlling the devices 12, 14, 16, 18 and/or processor to perform a particular method.

In the description that follows, devices such as server device 12, student devices 14, teacher devices 16, and administrator devices 18 are described performing certain acts. It will be appreciated that any one or more of these devices may perform an act automatically or in response to an interaction by a user of that device. That is, the user of the device may manipulate one or more input devices (e.g. a touchscreen, a mouse, or a button) causing the device to perform the described act. In many cases, this aspect may not be described below, but it will be understood.

The math technology industry focuses on building software that is meant to address student's learning issues and/or teach them math at the software-to-student level (i.e. via the software). The industry continues to pursue that path, adding functionality and new algorithms believing that ultimately if the right combination of functionality and algorithms is attained then the software can be an effective tool for the teaching and remediation of students issues in math.

There is a limit to the effectiveness of technology in this regard and, counter intuitively, is the system's ability to effectively influence the offline, human-to-human discussions may advantageously impact student learning. In some cases, current technologies are built with the goal to try to instruct or remediate based on if a student got a question right or wrong. In contrast, the present system 10 extracts researched misconceptions and informs teachers why students are not providing the correct response.

The way in which this offline discussion is influenced has been the realm of specialists because it requires a large amount of knowledge regarding specific learning issues related to curriculum that must first be understood, then painstakingly discovered by setting up questioning and looking for specific responses in the questioning from students. Given the knowledge needed, the number of students in a class, and the amount of time it takes to gather, analyze and properly respond to the affected students, this process is beyond the scope of a teacher's ability or time.

In an embodiment, the system 10 may automate the process via building specific curriculum linked to targeted issues in mathematics learning and having those targeted issues linked to remediation strategies designed to guide teacher to student discussions. The system 10 provides math improvement to teachers within the normal scope of classroom activity.

The system 10 may automatically bring to light specific misconception issues as they relate to a teacher's specific students 22 and then provide researched teaching strategies to the teacher to guide the discussions and activities for the teacher use with their students 22 to address the identified issue. Unlike previous methods, the system 10 may be facilitated during the normal scope of classroom activity and without the need for a specialist to be present.

As an example, it is described below that the devices 12, 14, 16, 18 may send information to the server device 12. For example, a student using the student device 14 may manipulate one or more input devices (e.g. a mouse and a keyboard) to interact with a user interface displayed on a display of the student device 14 to respond to questions. Generally, the device may receive a user interface from the network 20 (e.g. in the form of a webpage). Alternatively or in addition, a user interface may be stored locally at a device (e.g. a cache of a webpage or a mobile application).

Server device 12 may be configured to receive a plurality of information, one from each of the plurality of student devices 14, one from each of a plurality of teacher devices 16 and one from each of a plurality of administrator devices 18. Generally, the information may comprise at least an identifier identifying the student, teacher, or administrator. For example, the information may comprise one or more of a username, e-mail address, password, or social media handle.

In response to receiving information, the server device 12 may store the information in storage database. The storage may correspond with secondary storage of the device 12, 14, 16, 18. Generally, the storage database may be any suitable storage device such as a hard disk drive, a solid state drive, a memory card, or a disk (e.g. CD, DVD, or Blu-ray etc.). Also, the storage database may be locally connected with server device 12. In some cases, storage database may be located remotely from server device 12 and accessible to server device 12 across a network for example. In some cases, storage database may comprise one or more storage devices located at a networked cloud storage provider.

The student device 14 may be associated with a student account. Similarly, the teacher device 16 may be associated with a teacher account and the administrator device 18 may be associated with a administrator account. Any suitable mechanism for associating a device with an account is expressly contemplated. In some cases, a device may be associated with an account by sending credentials (e.g. a cookie, login, or password etc.) to the server device 12. The server device 12 may verify the credentials (e.g. determine that the received password matches a password associated with the account). If a device is associated with an account, the server device 12 may consider further acts by that device to be associated with that account.

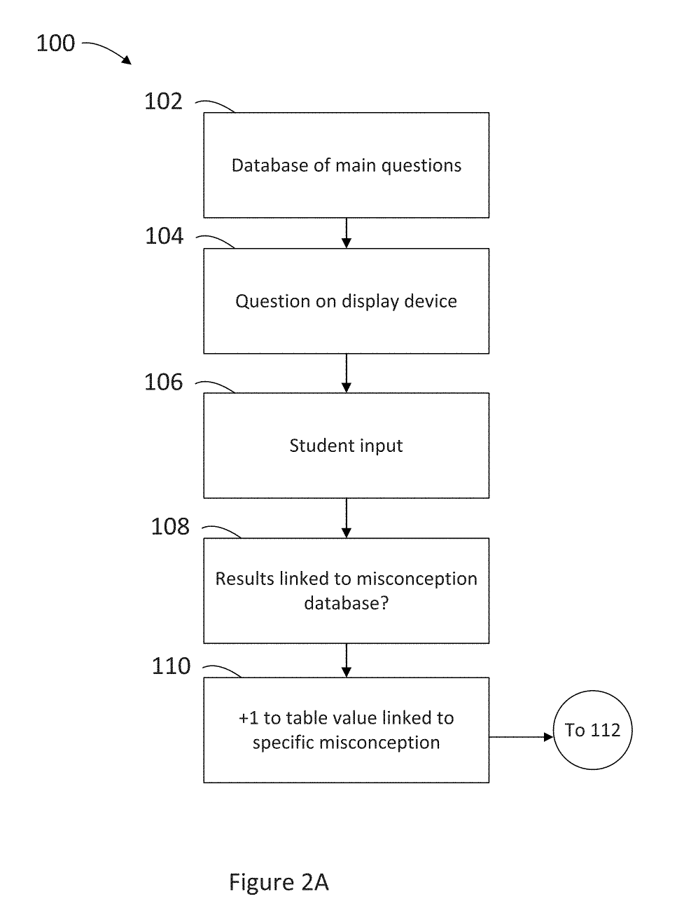

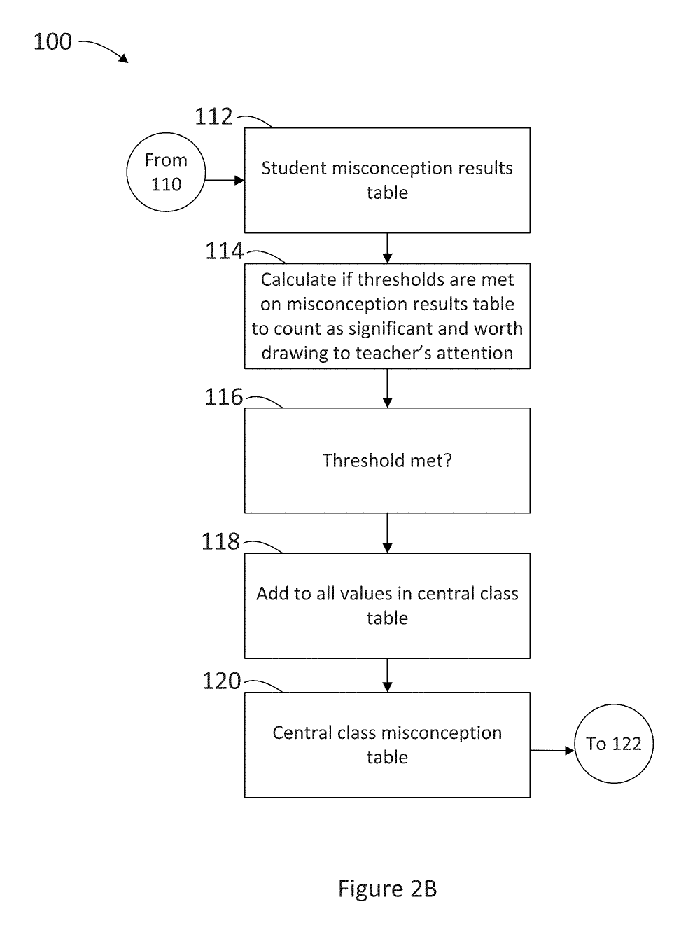

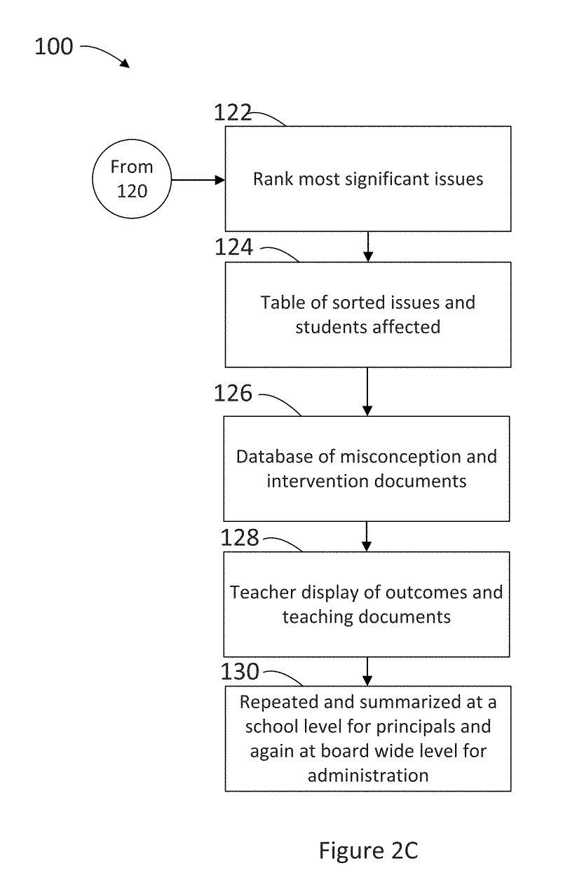

FIGS. 2A, 2B, and 2C illustrate a diagnosing and remediating misconception method 100, in accordance with an embodiment. The method 100 is broken down into three general groupings: (1) collecting evidence, (2) coordinating insights, and (3) supporting implementation. In a particular example, the diagnosing and remediating misconception method 100 is particularly advantageous for mathematics based learning. Unlike other subjects, learning in mathematics is cumulative and concepts build upon themselves. The effects of a misunderstanding or misconception therefore are presented in predictable ways as concepts are explored or built up. With the proper expertise these misconceptions can be timely identified and with, guidance of a teacher, can be addressed.

To get started with the method 100, the school board sends email invitations to school administrators, who then invite their teachers to register for particular grade (e.g. 3-10) and classes (e.g. Math). In an alternative, teachers directly use the diagnosing and remediating misconception method 100, for example via a software application.

At 102, the server 12 includes a database of main diagnostic questions. Collecting evidence includes determining what concepts the students are struggling with understanding.

At 104, the teacher device 14 displays, for example with a projector 24 onto a display screen 26, the diagnostic questions for viewing by the students 22. The diagnostic questions may be for example multiple choice questions or open answers that have predetermined wrong answers that are selected by the system in order to determine whether misconceptions are present.

In an embodiment, the teachers use the system to make it fun for students to learn and practice math either as a group or individually. Students may share their thinking and learn collaboratively. In an embodiment, the teachers may run an online math quiz that feels more like a game.

In a variant embodiment, the students run a self-paced program within or outside of the classroom, displayed on the student device 14. The self-paced program may include a ‘mission’ assigned by the teacher that includes the curriculum that the teacher would like to see the student understand.

At 106, the students 22 input responses to the diagnostic questions into the student devices 14.

At 108, the responses are received by the server 12 and the server 12 determines if the responses are linked to a misconception in the misconception database. Specific wrong answers are designed into the diagnostic questions and when students select the specific wrong answers, the responses are counted towards the linked misconception. If a response linked to the same misconception is selected a predetermined number of times a misconception flag is triggered for that student and indicated to the teacher. The predetermined number of times for the misconception flag may be determined based on the total possible times the student could have responded with the response linked to the misconception versus the times that the student did respond with the response linked to the misconception.

The server device 12 looks for misconceptions that prevent students from learning a new concept. There may be a considerable number of different and varying misconceptions with varying remediation strategies. For example, in a grade 9 math class, there are at least 18 major misconceptions and when multiplied across a class of 25 students, there may be a large volume of data to deal with. Further, the misconceptions may be unrecognizable to a teacher. For example, Table A below illustrates exemplary misconceptions for exemplary topics.

TABLE A

| Topic | Reference code and description of remediation issue |
|---|---|
| Fractions | Students may struggle with fraction comparisons and |
| | operations as well as when to apply the various operations. |
| | Some of the problems include: |
| | FR001 • misunderstandings about how to create equivalent |
| | fractions, e.g., adding the same amount to both numerator and |
| | denominator |
| | FR002 • misunderstandings about how to compare fractions when |
| | the denominators are not the same |
| | FR003 • adding (or subtracting) fractions by adding the |
| | numerators and adding (or subtracting) the denominators |
| | FR004 • not recognizing that fractions can only be added or |
| | subtracted if they are parts of the same whole |
| | FR005 • lack of understanding that a/b × c/d is a portion of c/d if |
| | a/b is a proper fraction |
| | FR006 • misinterpreting a remainder when dividing fractions, e.g., |
| | thinking that ½ ÷ ⅓ = ⅙ (since ½ − ⅓ = ⅙) instead of 1/12 |
| | FR007 • inverting the wrong fraction when dividing fractions using |
| | an invert-and-multiply strategy |
| | FR008 • inability to extend knowledge of comparisons and |
| | operation rules with proper fractions to improper fractions and/or |
| | mixed numbers |
| | FR009 • multiplying mixed numbers by separately multiplying |
| | whole number parts and fraction parts |
| Decimals | Students may struggle with decimal multiplication and |
| | division. Some of the problems include: |
| | D001 • not estimating to see if an answer makes sense |
| | D002 • misplacing of a decimal point in the answer |
| | D003 • not explaining why the processes for multiplying and |
| | dividing are what they are |
| | D004 • not applying the order of operations rules properly |
| Integers | Students may struggle with integer operations and some |
| | even with integer representations and comparisons. Some of |
| | the problems include: |
| | I001 • thinking about size of a number solely in terms of distance |
| | from zero or absolute value rather than location (e.g., thinking that −40 |
| | is more than −3 since 40 is more than 3) |
| | I002 • confusion between adding and subtracting, when negatives |
| | are involved |
| | I003 • lack of attention to the order in which numbers are |
| | subtracted, e.g., not realizing that −3 − (−4) is not the same |
| | as −4 − (−3) |
| | I004 • misapplication of learned rules (e.g., applying the rule that |
| | two negatives make a positive in a situation like −3 − 4) |
| | I005 • lack of fluency with whole number operations, particularly |
| | subtraction, multiplication, or division |
| Proportional | Students may struggle when solving problems involving |
| Reasoning | ratios, rates, and percent. Some of the problems include: |
| | PR001 • comparing numbers additively rather than multiplicatively, |
| | e.g., believing that the ratio 4:6 is equivalent to the ratio 6:8 |
| | since you added 2 both times |
| | PR002 • difficulty justifying why two ratios or rates are equivalent |
| | other than describing mechanical procedures |
| | PR003 • confusing the various ratios involved in a single situation. |
| | PR004 • lack of understanding that solving a ratio, rate, or percent |
| | problem always involves determining an equivalent ratio in a |
| | preferred form for that particular situation |
| | PR005 • difficulty solving a percent problem when the whole is the |
| | unknown, e.g., a student is able to calculate 30% of 50 but has |
| | difficulty calculating the number for which 15 is 30%. |
| | PR006 • inability to draw pictures to model a ratio, rate, or percent |
| | situation to help when a solution is not obvious |
| | PR007 • inability to determine an equivalent ratio when the terms |
| | are not whole numbers or when the terms of one ratio are not |
| | integer multiples of the terms of the other |
| | PR008 • lack of comfort with the notion of what a percent greater |
| | than 100% means |
| | PR009 • difficulty distinguishing between a percent of and a |
| | percent change |
| | PR010 • difficulty dealing with decimal percents, e.g., thinking that |
| | 0.5% of 20 is 10 |
| Powers and | Students may struggle with powers, roots and the |
| Roots | Pythagorean theorem. Some of the problems include: |
| | P&R001 • mixing up what a perfect square is and what a square |
| | root is |
| | P&R002 • not recognizing the different roles of the base and the |
| | exponent in a power |
| | P&R003 • lack of understanding of what a square root means |
| | when the root is not a whole number |
| | P&R004 • inability to estimate square roots that are not whole |
| | numbers |
| | P&R005 • not recognizing the relationship between √n and √n00 |
| | P&R006 • confusion about the relative sizes of squares and |
| | square roots of proper fractions |
| | P&R007 • over-generalizing the Pythagorean theorem; applying it |
| | to non-right triangles |
| | P&R008 • inability to determine a missing leg length in a right |
| | triangle (in contrast to a missing hypotenuse length) |
| Two- | Students may struggle with calculating areas of |
| Dimensional | parallelograms, triangles, trapezoids, circles and composite |
| Measurement | shapes or circumferences of circles. Some of the problems |
| | include: |
| | TDM001 • using the adjacent sides of a parallelogram rather than |
| | a base and height to determine its area |
| | TDM002 • taking half of both the height and base to calculate the |
| | area of a triangle |
| | TDM003 • multiplying the height by either only one base or the |
| | product of the two bases rather than half the sum of the two bases |
| | to determine the area of a trapezoid |
| | TDM004 • using a third side length, rather than a height, to |
| | determine the area of a trapezoid |
| | TDM005 • an inability to visualize how to decompose a shape into |
| | simpler shapes to calculate its area |
| | TDM006 • difficulty deducing information to indirectly determine |
| | necessary measurements of a composite shape |
| | TDM007 • mixing up the radius and diameter in formulas for the |
| | area and circumference of a circle |
| | TDM008 • lack of awareness that it is sometimes useful to |
| | subtract the area of one shape from the area of another to |
| | determine the area of a particular shape |
| | TDM009 • inability to apply the measurement formulas in more |
| | complex situations |
| | TDM010 • confusing perimeter with area or area with perimeter |
| Measurement - | Students may struggle with volumes and surface areas of |
| Volume | prisms and cylinders. Some of the problems include: |
| | MV001 • difficulty applying the area formulas required to |
| | determine the areas of bases of prisms and/or cylinders |
| | MV002 • mixing up the variable h, representing the height of the |
| | entire prism, with the variable h used to determine the area of a |
| | triangular or parallelogram base |
| | MV003 • not including all faces when determining surface area |
| | MV004 • confusing volume and surface area or not recognizing |
| | which is needed in a particular situation |
| | MV005 • difficulty deducing information to indirectly determine |
| | necessary measurements of a shape when they are not provided. |
| | MV006 • inability to apply either 2-D or 3-D measurement |
| | formulas in more complex situations |
| Algebraic | Students may struggle when working with algebraic |
| Expressions | expressions and equations. Some of the problems include: |
| and | AEE001 • depending too heavily on key words when attempting to |
| Equations | translate verbal expressions into algebraic form |
| | AEE002 • lack of understanding of the function of a variable |
| | AEE003 • not being comfortable with certain conventions, e.g., |
| | that 2b means two times b |
| | AE004 • not recognizing that any algebraic expression can be |
| | described in many different ways |
| | AE005 • not recognizing that an equality sometimes describes a |
| | fact related to a single value, |
| | sometimes describes an “identity” true for all values, and |
| | sometimes describes a relationship between two quantities. |
| | AE006 • lack of fluency with integer operations, which makes |
| | simplification of expressions difficult |
| | AE007 • not recognizing the rules for substitution. |
| | AE008 • lack of fluency with BEDMAS rules when substituting |
| | AE009 • not recognizing the relationship between the way a |
| | pattern grows and the algebraic expression describing its general |
| | term |
| Solving | Students may struggle in solving first-degree equations. |
| Equations | Some of the problems include: |
| | SE001 • lack of fluency with integer and fraction operations |
| | required to solve an equation |
| | SE002 • dividing through only some of the terms of an equation, |
| | e.g., changing 4x − 2 = 28 to x − 2 = 7 instead of x − 0.5 = 7 |
| | SE003 • discomfort with equations where the coefficient is |
| | negative, e.g., equations such as 14 − 2m = 26 (as opposed to |
| | 14 + 2m = 26) |
| | SE004 • not knowing what to do when solutions are neither whole |
| | numbers nor integers |
| | SE005 • lack of familiarity with equations where the unknown is |
| | not on the left (e.g., not sure what to do with 3 = 2 + 4m as |
| | compared to 4m + 2 = 3) |
| | SE006 • discomfort with equations where the variable appears on |
| | both sides |
| | SE007 • lack of understanding that there can be more than one |
| | solution in certain circumstances, e.g., 2n − 1 = n + 3 + n − 4 has |
| | many solutions |

At 110, if the response is linked to a misconception, a student misconception table is updated to add a value to the specific misconception.

At 112, the server 12 stores the student misconception table.

At 114, the server 12 calculates if a threshold is met on the student misconception results table where the misconception is significant and worth drawing to the teacher's attention. Certain types of answers or certain types of problems, regardless of the answer trigger misconception counts.

At 116, the server 12 determines if the threshold is met. The threshold is hit when the total number of hits as compared to the possible number of hits reaches the predetermined level.

At 118, if the threshold is met, the server 12 adds all values to a central class misconception table.

At 120, the server 12 stores the central class misconception table.

At 122, the server 12 ranks the most significant misconceptions and student issues. The server 12 recommends the best teaching practice to the teacher device 16 to use in right away or for class the next day. The significance of the misconception is based on the misconception with the largest count at this point. In an embodiment, the significance of the misconception may be based on a weighting element including any one or more of severity, frequency, and importance of the misconception.

The server 12 collects insights for delivery to the administrators device 20 for helping the administrators tailor professional development plans based on teachers' and students' needs. The insights may be ranked with a confidence interval (e.g., 99% confidence) and margin of error value (e.g., 3% margin of error) across any one or more of the schoolboard, the school, the teacher, the class, and the student. The confidence interval and margin of error value may be calculated based on the student population and number of students tested in the population.

Professional development tailored to students' needs may improve the efficacy of both teacher practice and student learning. The server 12 may also help teachers involve parents in their child's mathematical development. Administrators use the system to implement evidence-based professional development across their schools. The intervention details may be similar to those for the teachers and further include aggregate data for both the schoolboard overall and for each school using the system.

At 124, the server 12 stores a table of sorted issues and students affected.

At 126, the server 12 stores a database of misconceptions and interventions.

At 128, the server 12 provides the teacher device 16 with an outcome and teaching prescription document. Teachers are supported by experienced math coaching to provide pre- and post-feedback online. Principals and math leads may receive a starter kit and ongoing support to kick start and sustain effective professional learning communities (PLC's). When trained, school leaders can overcome the challenges of budgeting monthly time in teacher's schedule. Effective implementation of new, teaching practices. Building teacher buy-in and positive morale using PLCs including collecting constructive feedback and evidence of success.

In an embodiment, the PLC may include a webinar for the teachers. The teachers may get an alert if they have students struggling with one of the issues covered in the webinar. The webinar may be displayed on the teacher device 16 for online viewing. The PLC may also include the school administrator, such as a principal, encouraging a proper learning community in the school. The system 10 may provide data to guide the focus of the PLC.

At 130, the server 12 provides the administrator device 18 with repeated and summarized report, for example at a school level for principals. The administrator device 18 may be provided with details on what schools are affected by any misconception and the frequency of that misconception in the school or across the board. The report may include analysis of the students' responses and how the responses are linked to misconceptions to provide context to the insights. The school board receives recommendations to inform and justify their professional development plans. The server 12 may also provide the administrator device 18 with the repeated and summarized report for a the school board for school administrators.

The server 12 may also provide the administrator device 18 with the repeated and summarized report after sending the prescriptive plan to the teacher device 16. The report may represent a cumulative summary of misconceptions and, in particular, ones that are most statistically significant. Teacher devices 16 may receive get the results of the assessment right away after the student devices 14 have sent the responses.

Value to the administrator is having real time data and being able to provide professional development to schools or across the board that teachers see as relevant to their particular situation. The administrator, seeing the results on administrator device 18, knows teachers are also seeing it on the teacher devices 16 aligning the issues and providing the focus and devices by which to provide professional development around. For example, if the administrator sees that a common misconception is flagged by the system 10 at a school they cover, the administrator can take a number of actions including: offering to come to the school to discuss with teachers possible ways to remediate the issue, providing best lesson practices around the issue, co-teaching with teachers experiencing the issue with their students in order to explore different methods of remediation, and/or helping to deliver the remediation after school to affected students.

The server 12 may also provide a report, for a particular student 22, to the student's parent based on the misconceptions held by the particular student 22.

In some cases, a schoolboard wide training plan that has been pre-planned is deficient and the system 10 will notice the deficiency from the misconception and prescribe a training plan immediately before the students move on to the next concept. As math and science concepts often build off of one another, the system 10 may enable immediate and dynamic, day-to-day customization and feedback of the teaching plan. The system 10 may tighten the turnaround of teaching effectiveness in real time which would be otherwise inefficient and unfeasible because of the drain of teaching resources.

Implementing the system 10 as described may be particularly advantageous. In particular, getting this volume of disperse data at the board level may be expensive and difficult to retrieve without the system 10. Conventional systems may include sending out some sort of test that intrudes on the teachers time in the classroom and requires a compliance to get back, which is not easy for teacher to complete, resulting in incomplete responses. As the present system 10 fits into the teachers own teaching plans and the teachers use the system 10 on their own, the data collection happens in the background versus being a prescribed and mandated program. Further, getting the information back in real time may not be possible without the network of computer devices 12, 14, 16, 18. The system 10 may also reduce the amount of added teacher and human work to mark and aggregate results. Further, the system 10 may provide insights that may be otherwise difficult to recognize.

The system 10 may provide an efficient way for the administrator to receive the insight information and as well as content that has been linked to specific misconceptions that allows the administrator to know what insights are relevant and what the insights mean. For example, conventionally there may be a number of students suffering from the same misconception that can be remediated using the system 10. For example, getting a question wrong and knowing why the students is getting it wrong are two different things. The system 10 identifies why the student is getting the question wrong in order to be able to recommend the appropriate remediation.

Without the system 10, the teacher may not identify misconceptions. The teacher may be unable to build in assessments that are looking for particular underlying issues, mark the specific assessment, reveal the particular insights through aggregation and analysis of the results, and record which students seem most likely to be struggling with the issue built into the assessment. Because of the time, training, and amount of data involved, the system 10 may provide results that would otherwise be limited or non-existent.

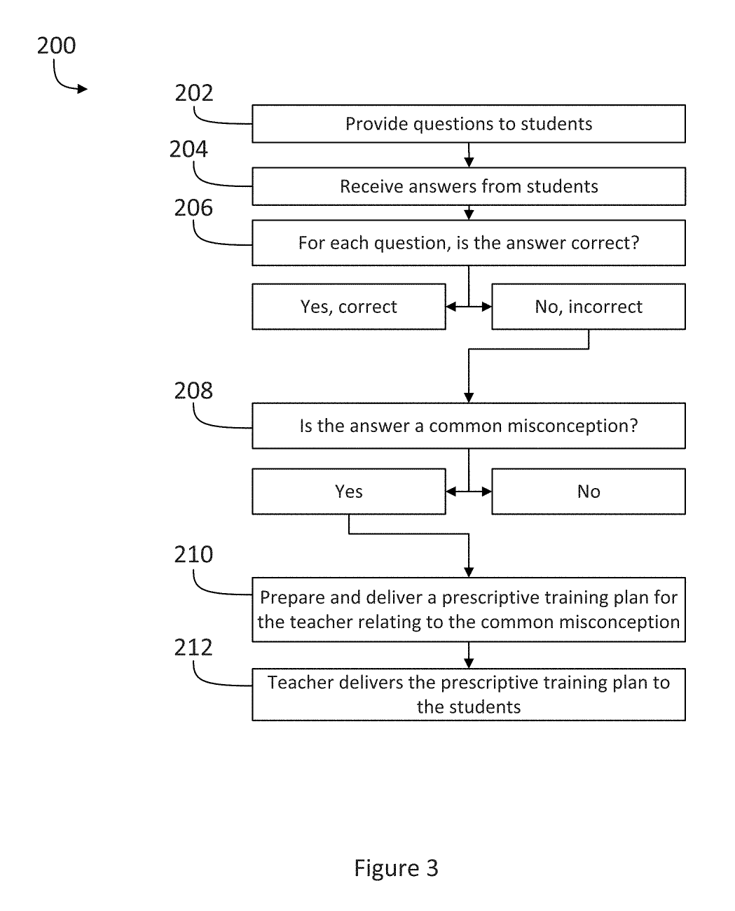

FIG. 3 illustrates a flow chart of a computer method 200 for identifying and remediating a misconception, in accordance with an embodiment. At 202, the server 12 provides diagnostic questions to the student devices 14. At 204, the server 12 receives responses from the student devices 14. At 206, the server 12 determines if the responses are correct or incorrect. At 208, where the responses are incorrect, the server 12 determines if the incorrect response is linked to a specific misconception. At 210, where the responses are linked to a specific misconception, the server 12 prepares a prescriptive training plan and sends the prescriptive training plan to the teacher device 16. The prescriptive training plan is a fixed lesson plan dealing with the specific misconception. The prescriptive training plan is built to encourage collaborative inquiry type remediation between the student and the teacher or between students and guided by the teacher to explore the issues in a way that helps the students realize the issues and make meaningful connections to the proper solution. The prescriptive training plan trains the teacher how to properly characterize a solution to the common misconception. At 212, the teacher device 16 receives the prescriptive training plan and the teacher user delivers the prescriptive training plan to the student users.

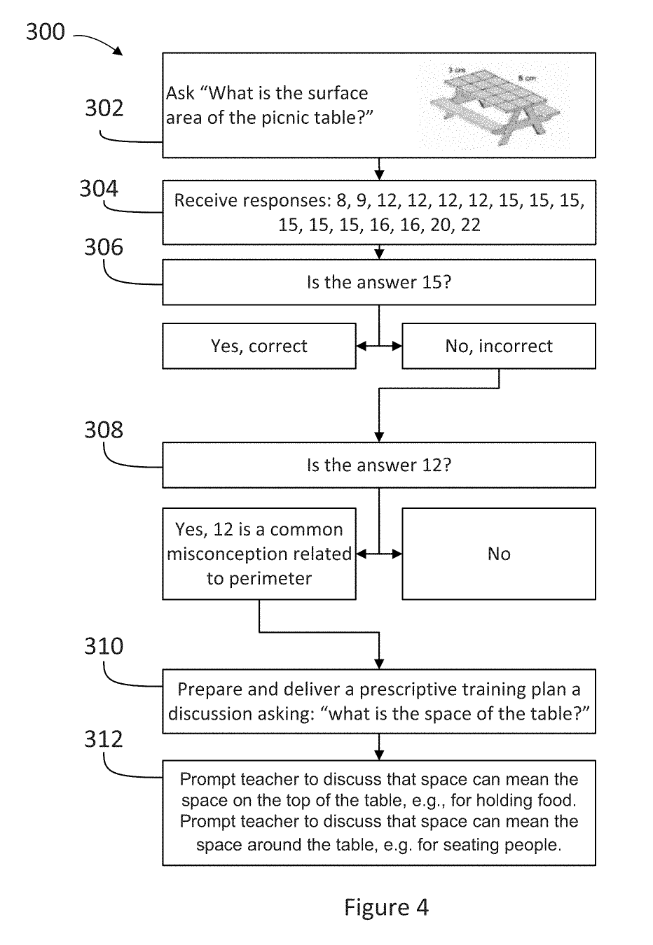

FIG. 4 illustrates an example computer method 300 for identifying and remediating a misconception, in accordance with an embodiment. At 302, the system asks the students “what is the surface area of the picnic table?” At 304, the students submit answers: 8, 9, 12, 12, 12, 12, 15, 15, 15, 15, 15, 15, 16, 16, 20, 22. At 306, if the answer is 15 then it is correct. If the answer is not 15, the answer is incorrect. At 308, if the answer is 12 (the perimeter) then it is a specific misconception around area versus perimeter. Where the significance threshold is met based on this misconception, the teacher is flagged that the student may have an issue with this misconception and, at 310, the system delivers a lesson plan to the teacher for perimeter versus area. The lesson plan includes a discussion asking: “what is the space of the table?” The teacher is prompted to discuss that space can mean the space on the top of the table, e.g., for holding food. And the teacher is also prompted to discuss that space can mean the space around the table, e.g. for seating people. In this example, the discussion around space on top of the table relates to surface area (the correct answer) and the discussion around space around the table for seating relates to perimeter (the specific misconception). The lesson plan is not simply a definition of area or perimeter but rather a way that the teacher can illicit the students to discover the differences and similarities between area and perimeter.

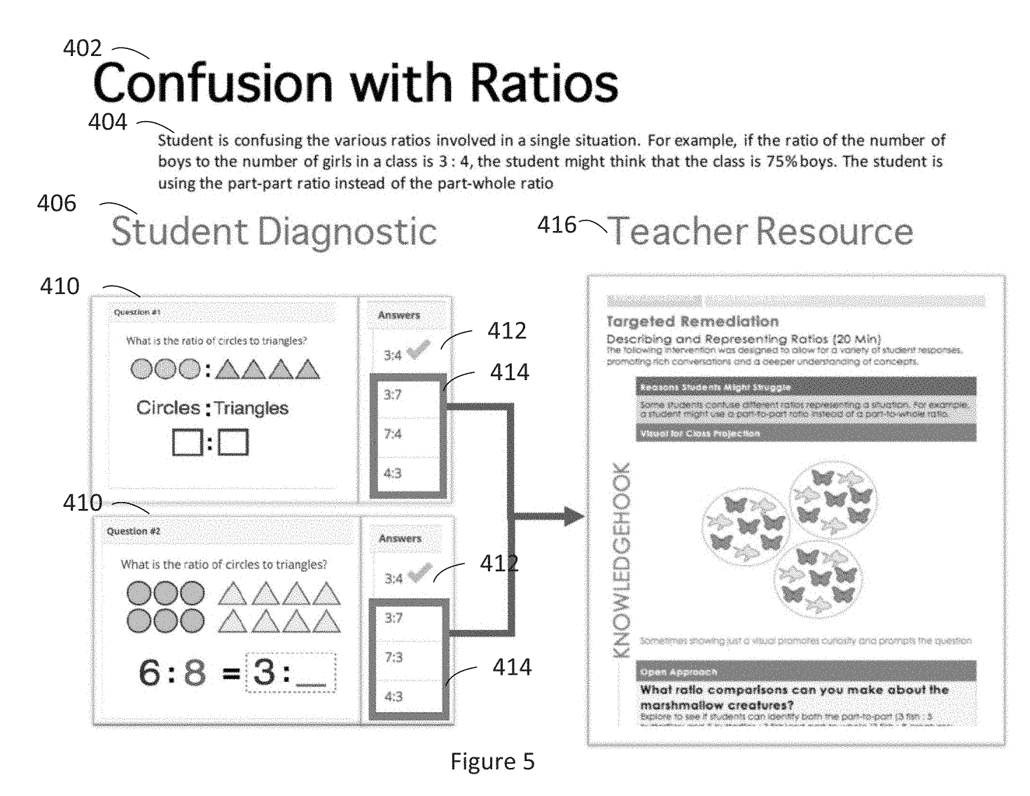

FIG. 5 illustrates a particular misconception 402 of a student diagnostic 406, and a teacher prescription 416. The misconception 402 relates to confusion with ratios and a descriptive example 404 of the misconception 402 is provided.

The student diagnostic 410 includes at least one question, a correct response 412, and an incorrect misconception response 414. The incorrect misconception response 414 informs the particular misconception 402 and the related teacher prescription 416.

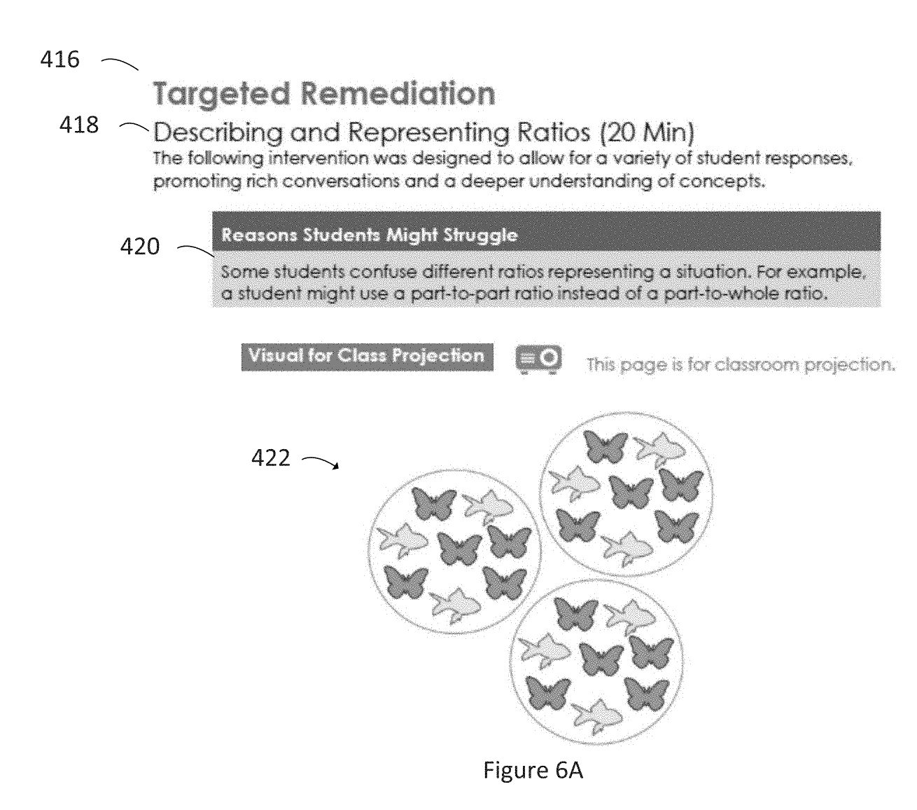

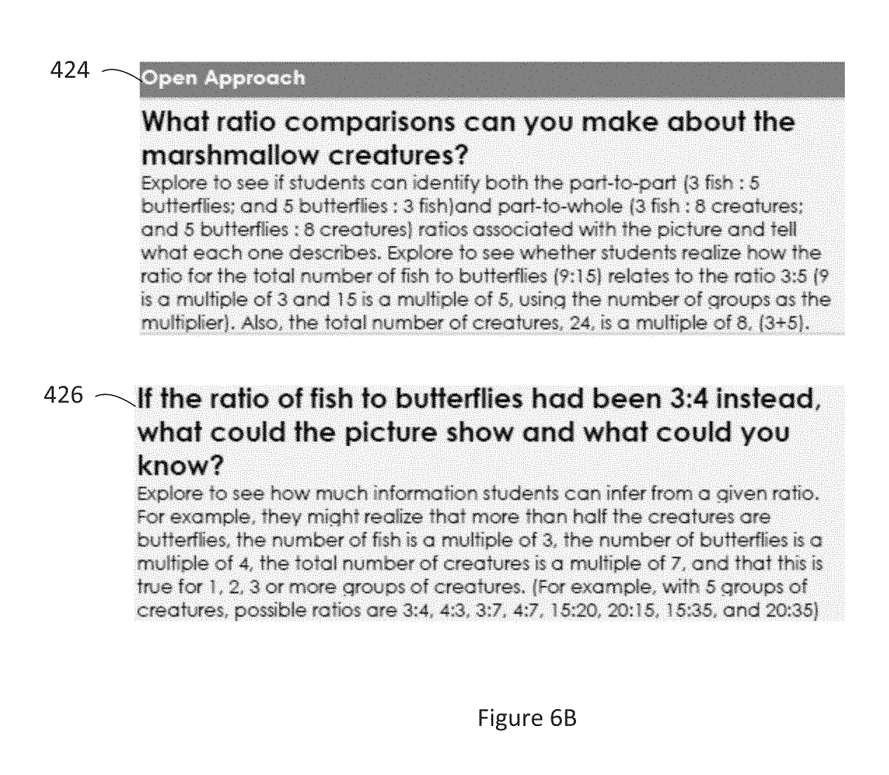

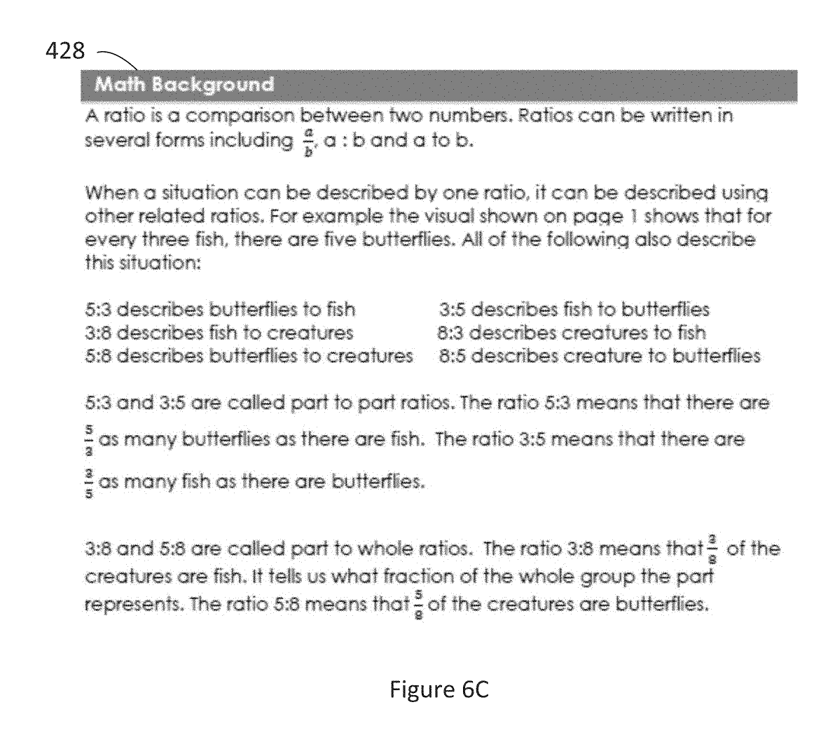

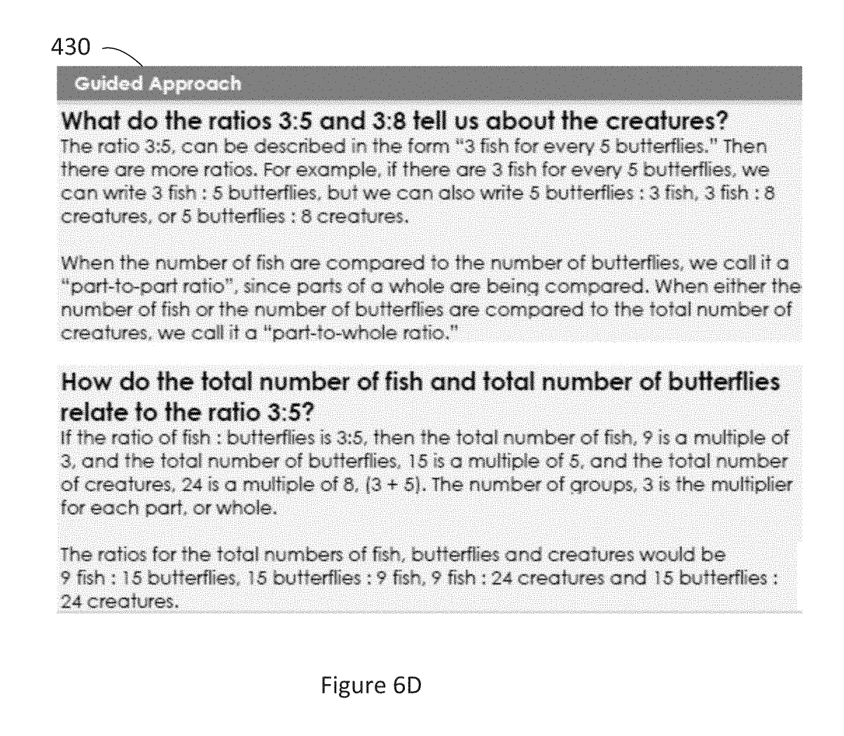

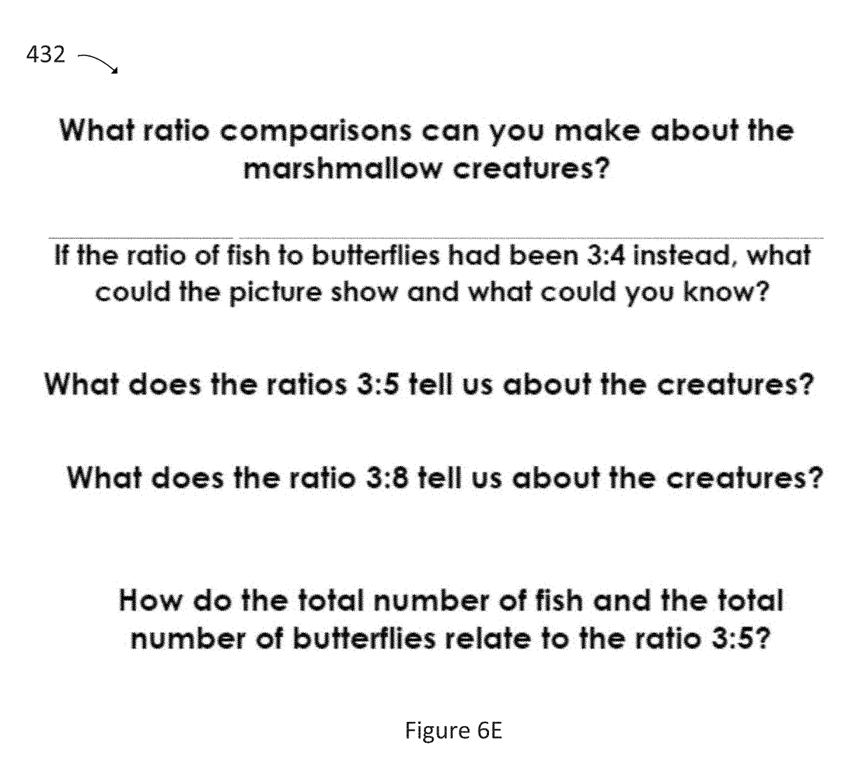

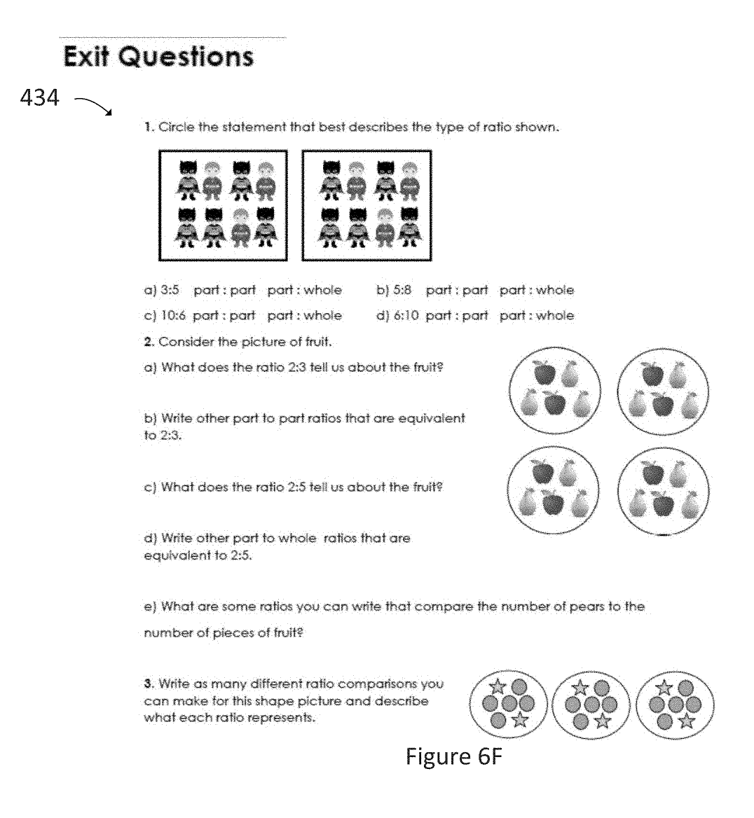

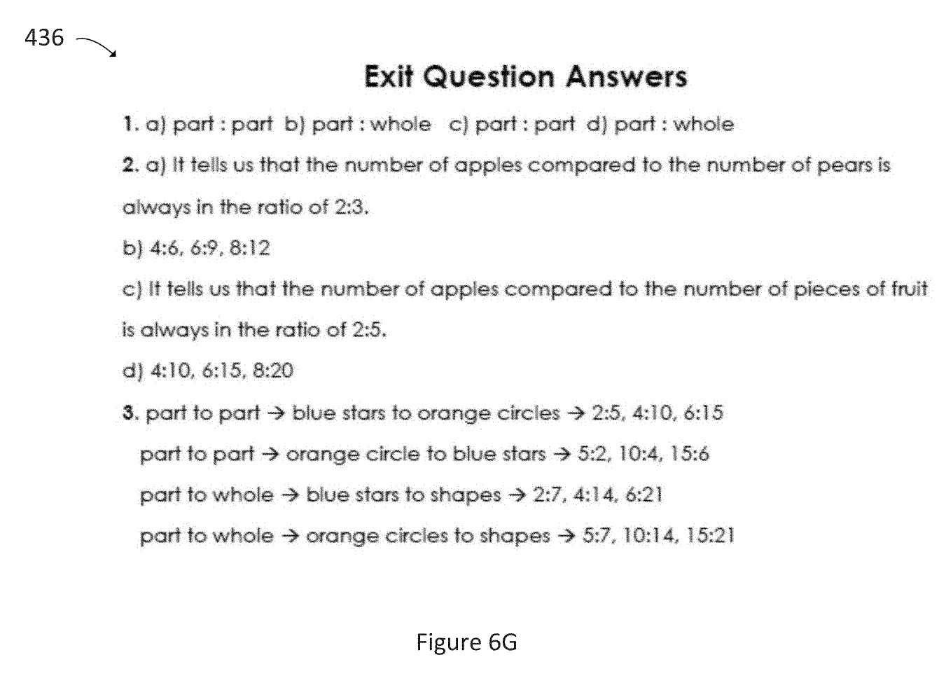

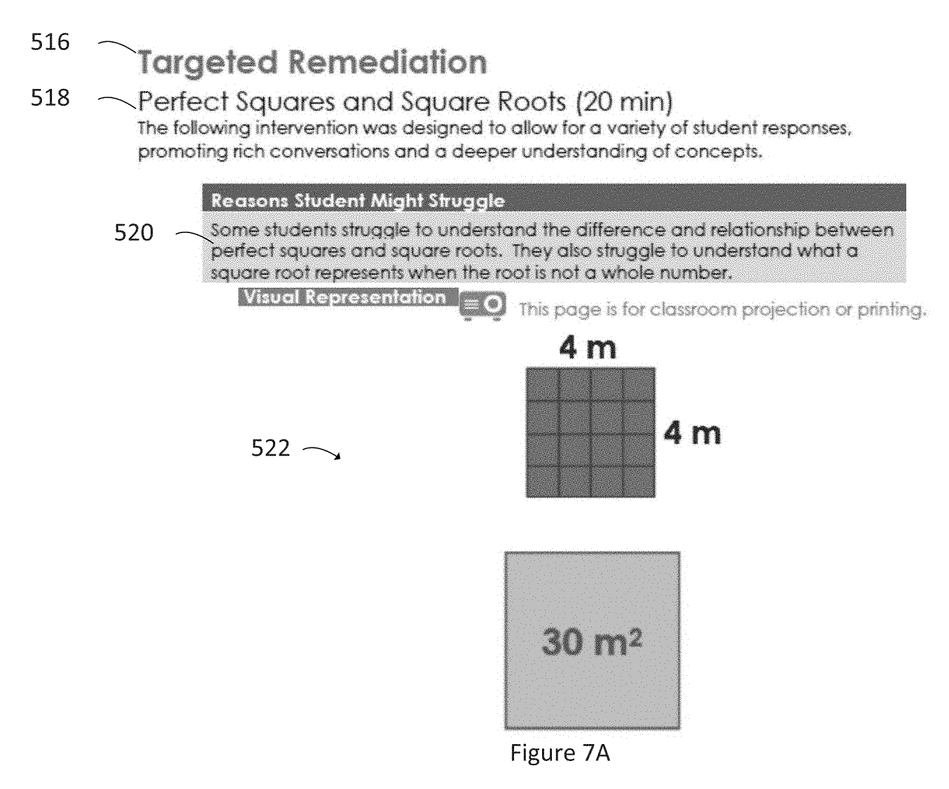

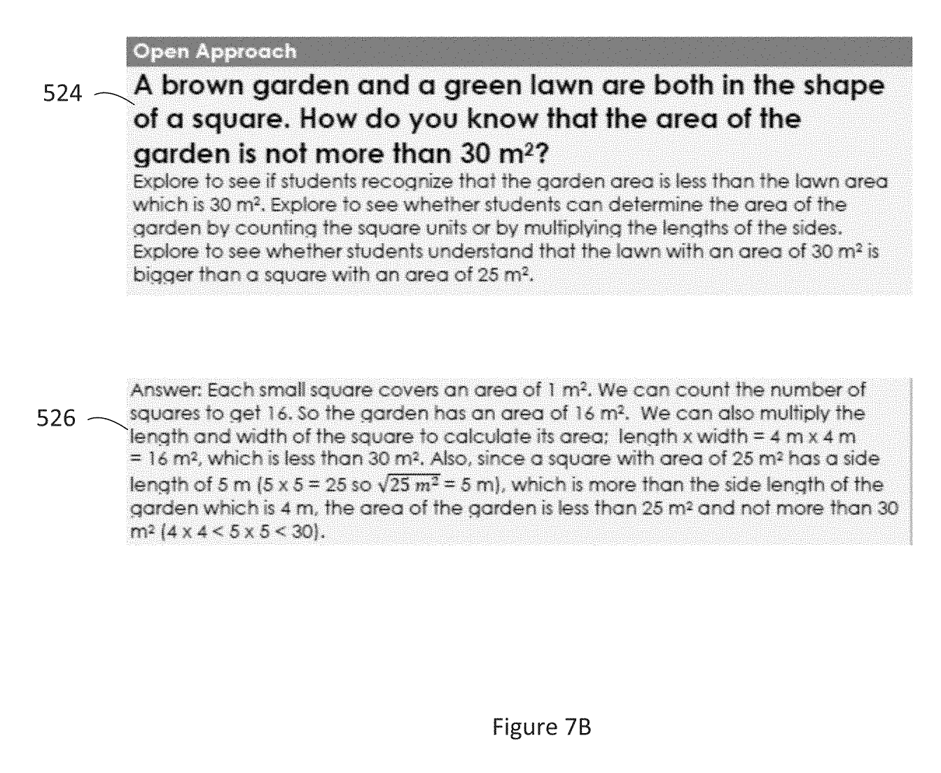

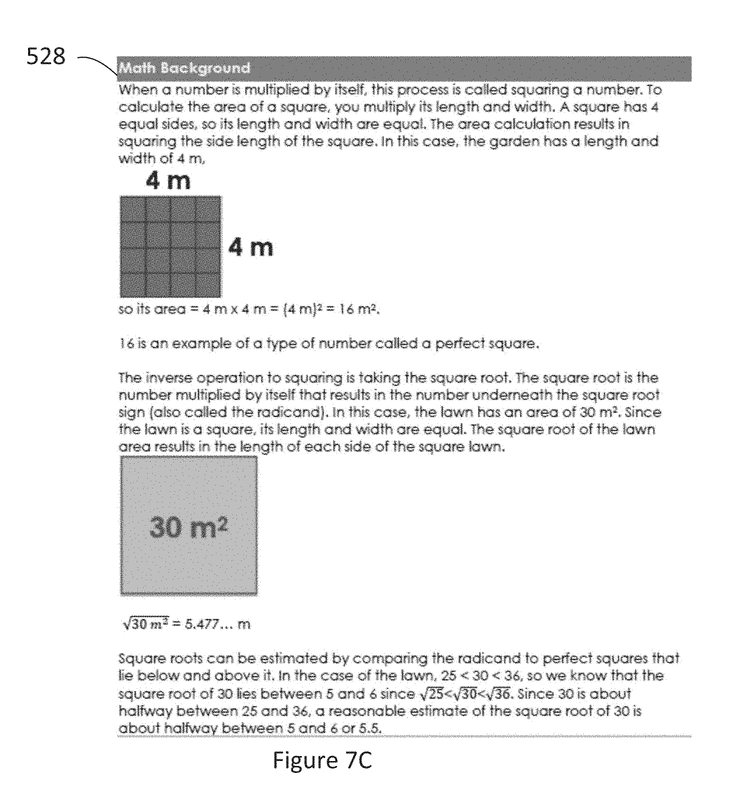

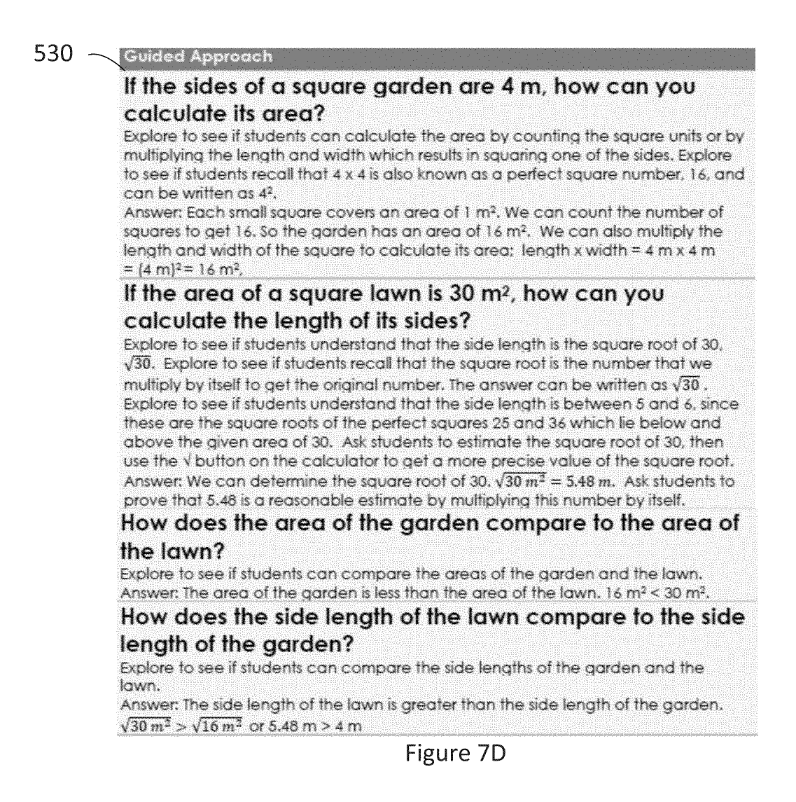

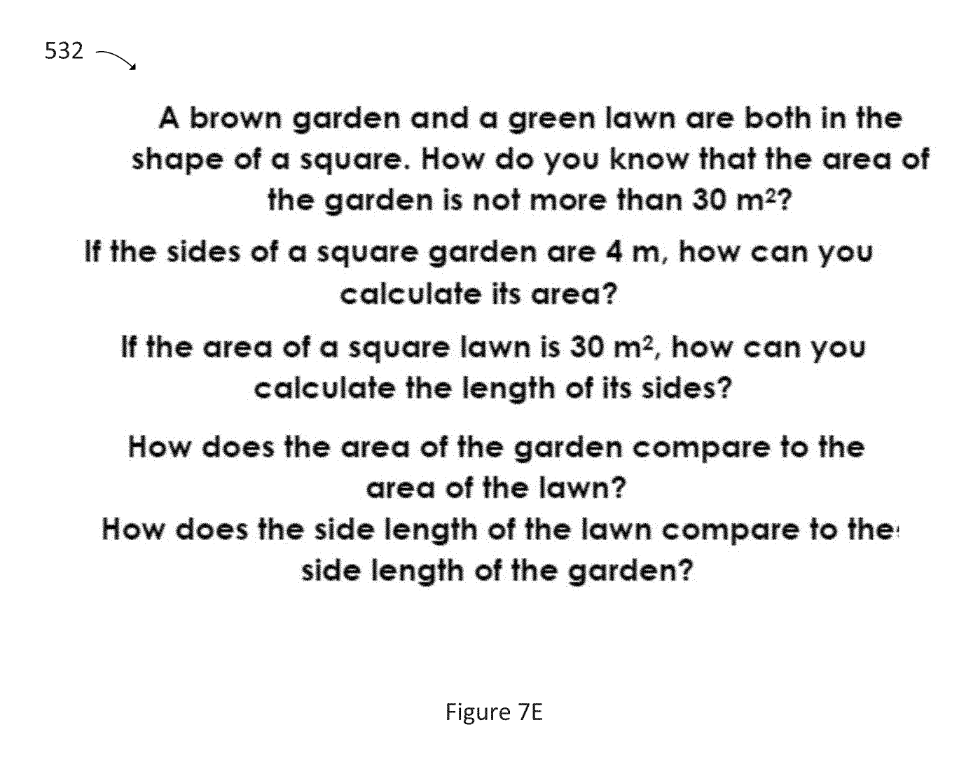

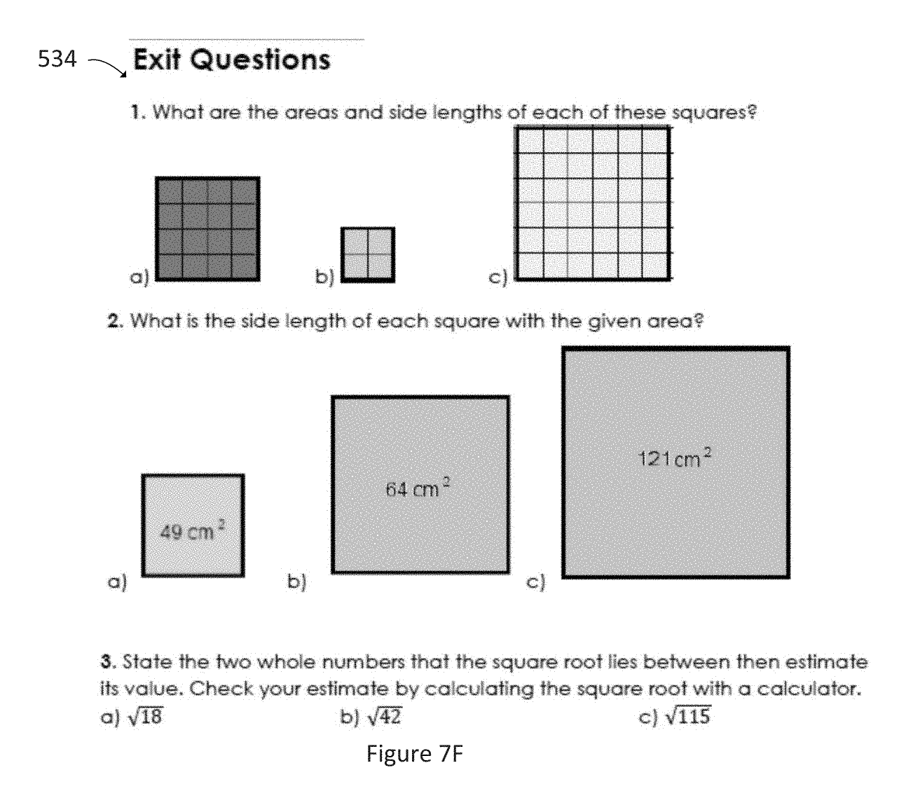

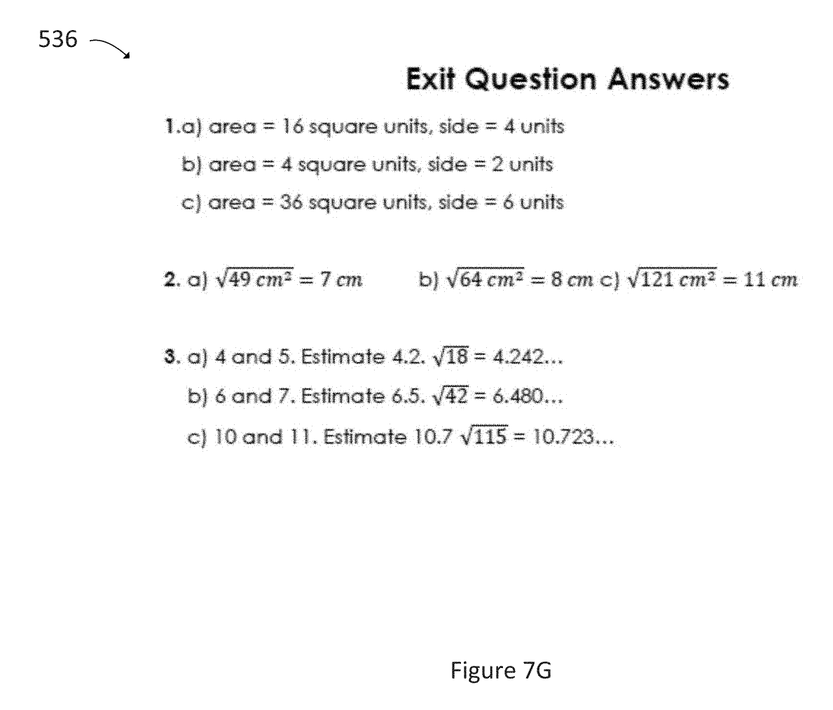

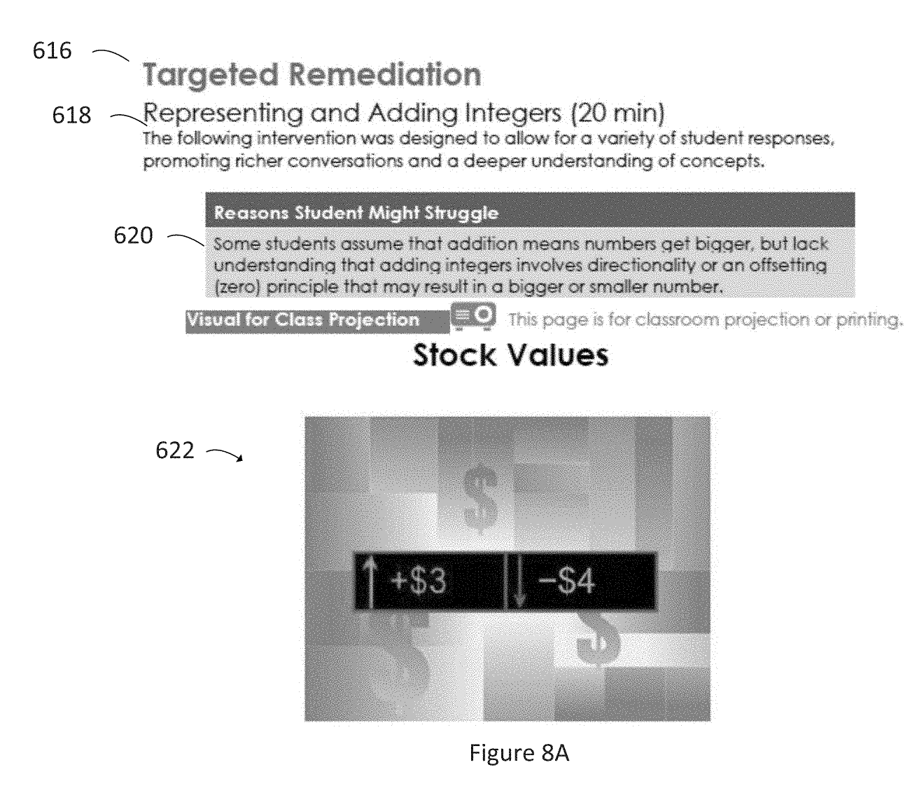

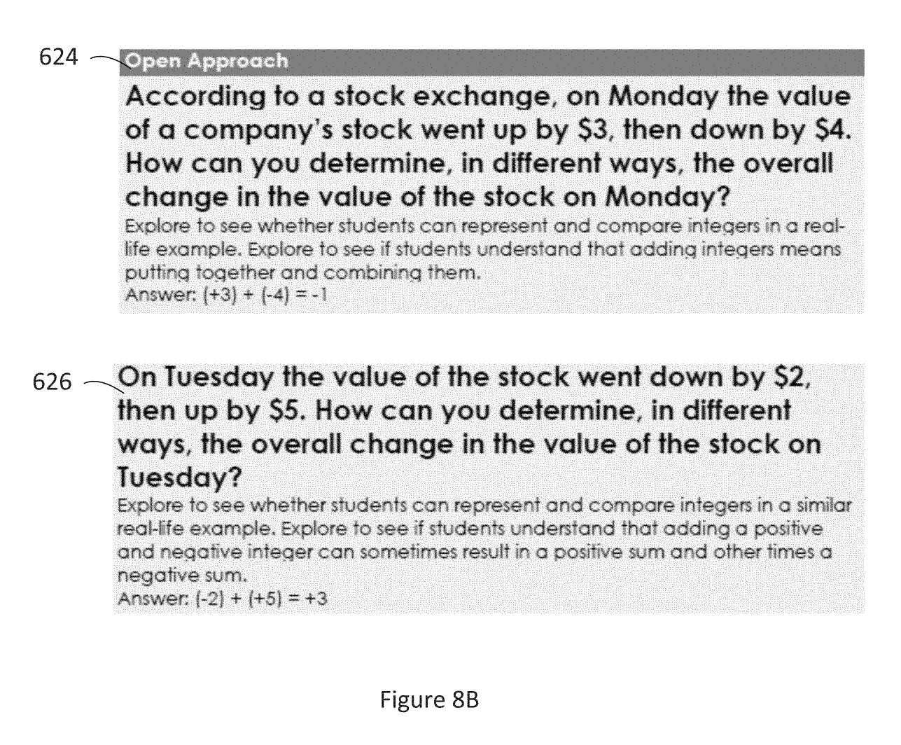

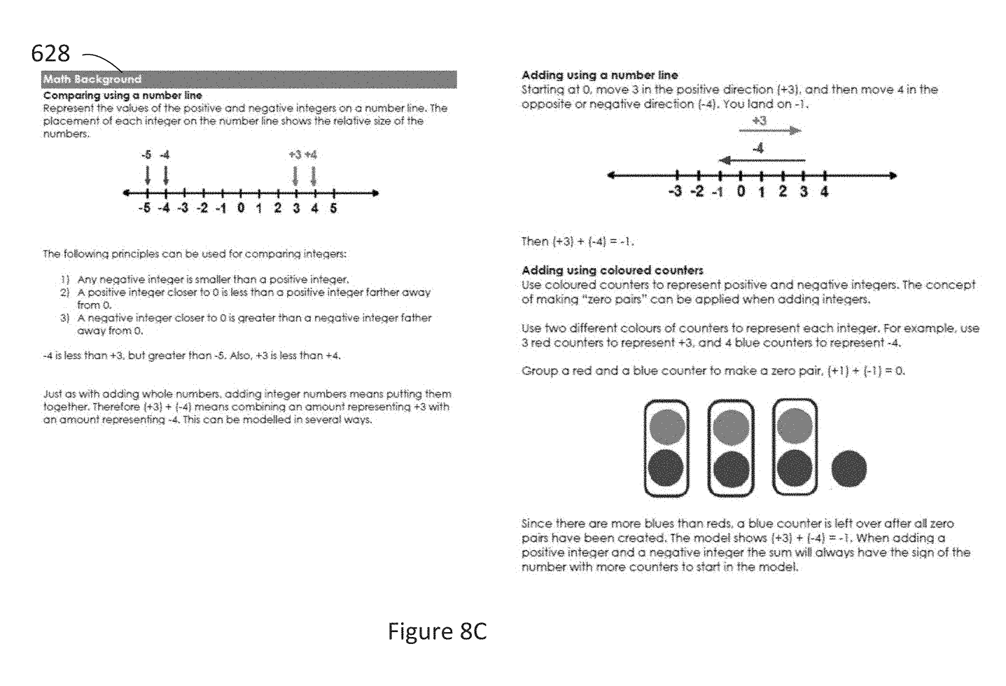

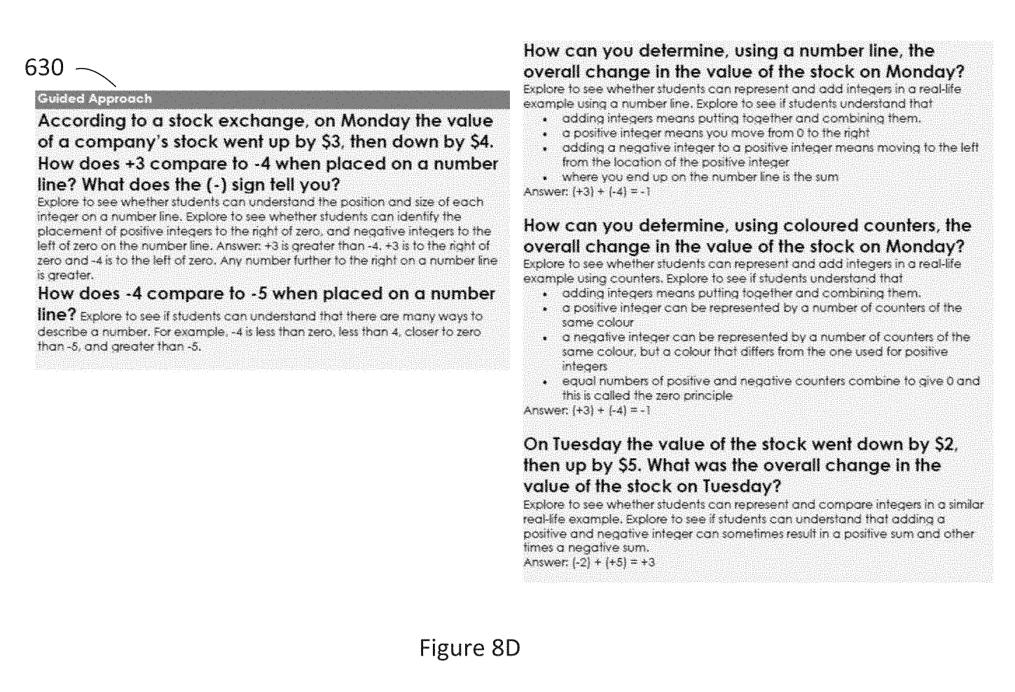

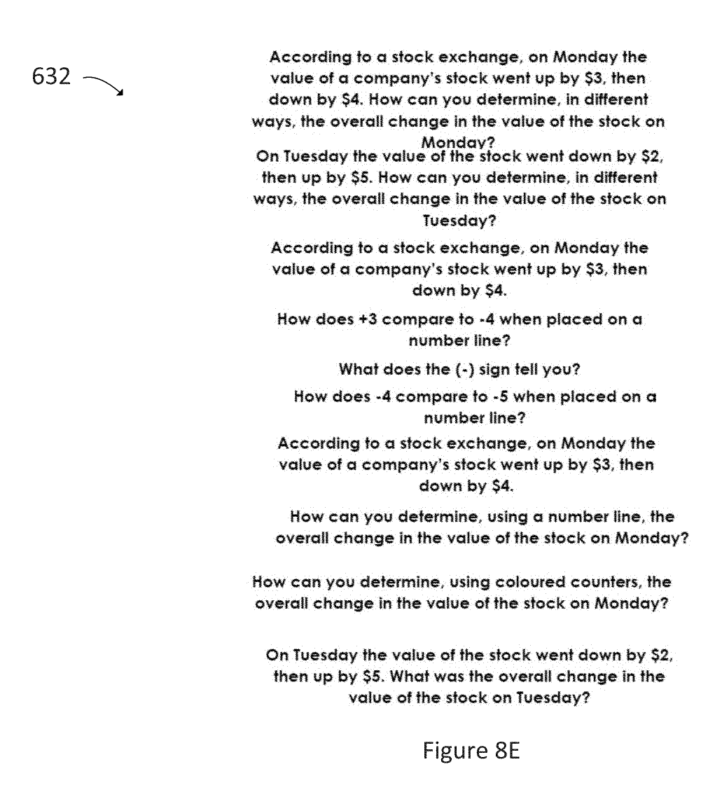

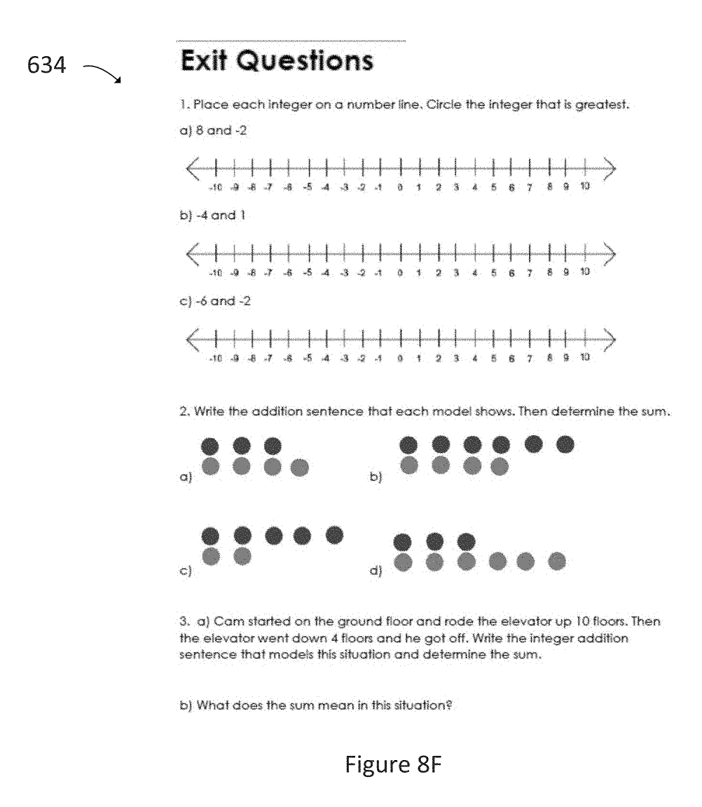

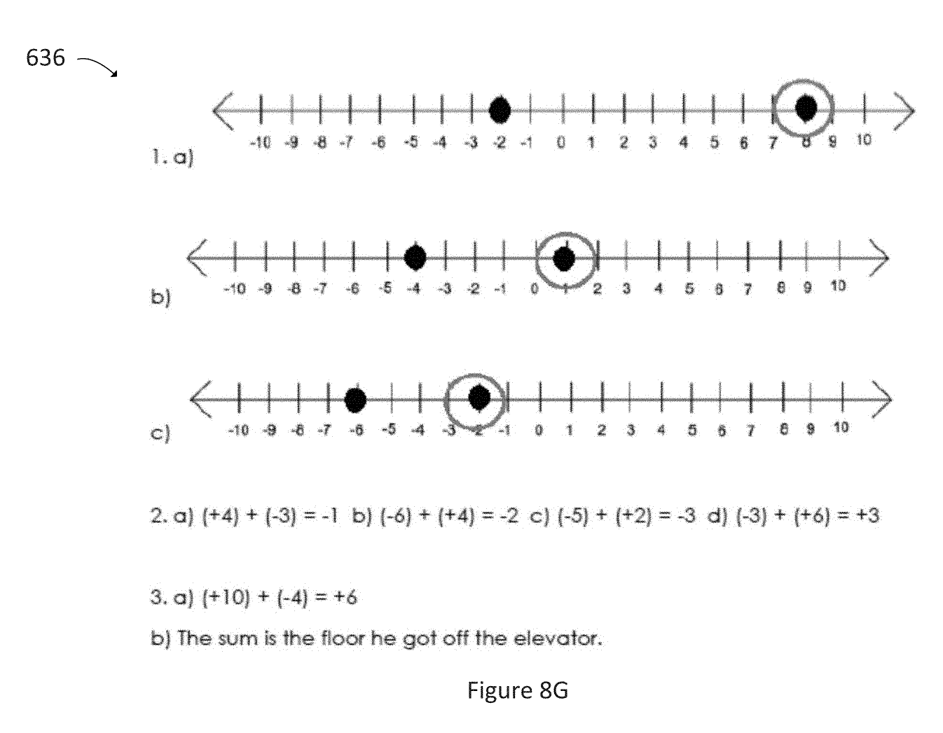

FIGS. 6A-6G illustrate the details of the teacher prescription 416, FIGS. 7A-7G illustrate the details of another example teacher prescription 516 and FIGS. 8A-8G illustrate the details of another example teacher prescription 616. In particular, the teacher prescription 416, 516, 616 includes visual elements for display to the students 22, such as on the display screen 26. The teacher prescription 416, 516, 616 also includes teacher only information for display only on the teacher device 16.

The teacher prescription 416, 516, 616 includes a misconception definition 418, 518, 618 that describes the issue faced by the student as well as misconception reasons 420, 520, 620 for why the student 22 may struggle with the misconception. The teacher prescription 416, 516, 616 includes a visual for class projection 422, 522, 622. The teacher prescription 416, 516, 616 also includes an open approach 424, 524, 624 including open ended question 426, 526, 626 that the teacher delivers directly to the students 22. The teacher prescription 416, 516, 616 also includes a background 428, 528, 628 describing the details of the underlying problem and the background of the particular misconception. The teacher prescription 416, 516, 616 may also include a guided approach 430, 530, 630 including specific questions that the teacher delivers directly to the students 22. Some of the open ended questions 426, 526, 626 and specific questions may be displayed to the students 22 (e.g. via projector 24), listed at 432, 532, 632. The teacher prescription 416, 516, 616 may also include a set of exit questions 434, 534, 634, for individual student 22 delivery or group delivery. The teacher prescription 416, 516, 616 may also include a set of answers 426, 526, 626 to the exit questions 434, 534, 634 so that the teacher can evaluate the effectiveness of the teacher prescription 416, 516, 616.

While the above description provides examples of one or more apparatus, methods, or systems, it will be appreciated that other apparatus, methods, or systems may be within the scope of the claims as interpreted by one of skill in the art.

1. A computer system for diagnosing and remediating at least one misconception, the system comprising:
a server device in communication, via a network, with a plurality of student devices each associated with a student user, at least one teacher device associated with a teacher user, and at least one administrator device associated with an administrator user;
wherein the server device is configured to:
provide diagnostic questions to the student devices;
receive responses from the student devices;
determine if the responses are linked to a misconception; and
where the response is linked to a misconception, send a prescriptive training plan to the teacher device.

2. The system of claim 1 wherein the server device is further configured to send the prescriptive training plan to the administrator device.

3. The system of claim 1, wherein the prescriptive training plan trains the teacher how to properly characterize a solution to the misconception.

4. The system of claim 1, wherein the teacher device receives the prescriptive training plan and the teacher user delivers the prescriptive training plan to the student users.

5. The system of claim 1, wherein the prescriptive training plan includes visual elements for display to the student users.

6. The system of claim 1, wherein the prescriptive training plan includes a misconception definition that describes the issue faced by the student as well as misconception reasons for why the student may struggle with the misconception.

7. The system of claim 1, wherein the prescriptive training plan includes an open approach including open ended questions that the teacher delivers directly to the students.

8. The system of claim 1, wherein the prescriptive training plan includes a background describing the details of the underlying problem and the background of the particular misconception.

9. The system of claim 1, wherein the prescriptive training plan includes a guided approach including specific questions that the teacher delivers directly to the students.

10. The system of claim 1, wherein the prescriptive training plan includes a set of exit questions, for individual student delivery or group delivery.

11. A method for diagnosing and remediating at least one misconception, the method comprising:
providing diagnostic questions to student devices;
receiving responses from the student devices;
determining if the responses are linked to a misconception;
where the response is a misconception, sending a prescriptive training plan to a teacher device.

12. The method of claim 11 further comprising sending the prescriptive training plan to an administrator device.

13. The method of claim 11, wherein the prescriptive training plan trains the teacher how to properly characterize a solution to the misconception.

14. The method of claim 11 further comprising, at the teacher device, receiving the prescriptive training plan.

15. The method of claim 11 further comprising delivering the prescriptive training plan to the student users.

16. The method of claim 11, wherein the prescriptive training plan includes visual elements for display to the student users.

17. The method of claim 11, wherein the prescriptive training plan includes a misconception definition that describes the issue faced by the student as well as misconception reasons for why the student may struggle with the misconception.

18. The method of claim 11, wherein the prescriptive training plan includes an open approach including open ended questions that the teacher delivers directly to the students.

19. The method of claim 11, wherein the prescriptive training plan includes a background describing the details of the underlying problem and the background of the particular misconception.

20. The method of claim 11, wherein the prescriptive training plan includes a guided approach including specific questions that the teacher delivers directly to the students.

21. The method of claim 10, wherein the prescriptive training plan includes a set of exit questions, for individual student delivery or group delivery.
